(19) United States
(12) Patent Application Publication
(10) Pub. No.: US 2025/0342350 A1
(43) Pub. Date: Nov. 6, 2025

(54) SOFTWARE TASK COMPLETION TIME ESTIMATOR

(71) Applicant: Microsoft Technology Licensing, LLC, Redmond, WA (US)

(72) Inventor: Nachiket Vishnu NAIK, Bothell, WA (US)

(21) Appl. No.: 18/654,316

(22) Filed: May 3, 2024

(51) Int. Cl. G06N 3/0475

(52) U.S. Cl. CPC G06N 3/0475

(57) ABSTRACT

Software compliance, security patching, and upgrading tasks may have similarities with one other. These peculiarities of this sort of software projects and tasks and underlying steps lend to automation of estimating completion time thereof. The presently disclosed technology leverages the peculiarities of a subset of predictable and repeatable software tasks to apply large-language models (LLMs) and image processing artificial-intelligence (AI) to automatically estimate the completion time of a task given the steps required. The presently disclosed technology further includes a software tool backed by an artificial intelligence model that iteratively tunes a training data set to update and optimize the completion time of a task given the steps required.

### BACKGROUND

Software project and task completion time can be estimated in a variety of ways but is typically a manual process as software development tasks are not homogenous and typically no two projects or tasks are the same. Thus, such estimations of completion time are time consuming and difficult to accurately accomplish.

### SUMMARY

Various implementations of the presently disclosed technology include a method for estimating time to implement predictable and repeatable software tasks. The method comprises providing training data for a machine-learning (ML) enabled time estimation engine that includes, for each of multiple previously-implemented software tasks, a text description of operations performed to implement the software task and a total time required to implement the software task. The method further comprises providing as input to the time estimation engine, a text description of new operations for a new software task. The method further comprises receiving as output from the time estimation engine, an estimated time required to implement the new operations to complete the new software task.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system for estimating software task completion time.

FIG. 2 illustrates an example software task completion time estimator tool.

FIG. 3 illustrates example operations for estimating software task completion time.

FIG. 4 illustrates an example schematic of a processing device suitable for implementing aspects of the presently disclosed technology.

### DETAILED DESCRIPTION

Software compliance, security patching, and upgrading tasks can apply to a large number of software projects and can impact many software teams in a similar and repeatable manner and can have similar or the same steps. Thus, there is a higher likelihood that the same steps will have similar effort costs across different projects. Further, such tasks may have similarities with one another (e.g., upgrading the version of one package may be similar to upgrading another package or the same package with a subsequent version).

The presently disclosed technology leverages the peculiarities of a subset of predictable and repeatable software tasks (e.g., software compliance, security patching, and upgrading tasks) to apply large-language models (LLMs) and image processing artificial-intelligence (AI) to automatically estimate the completion time of a task given the steps required. The presently disclosed technology further includes a software tool backed by an artificial intelligence model that iteratively tunes a training data set to update and optimize the completion time of a task given the steps required. Further benefits and implementation details are explored below.

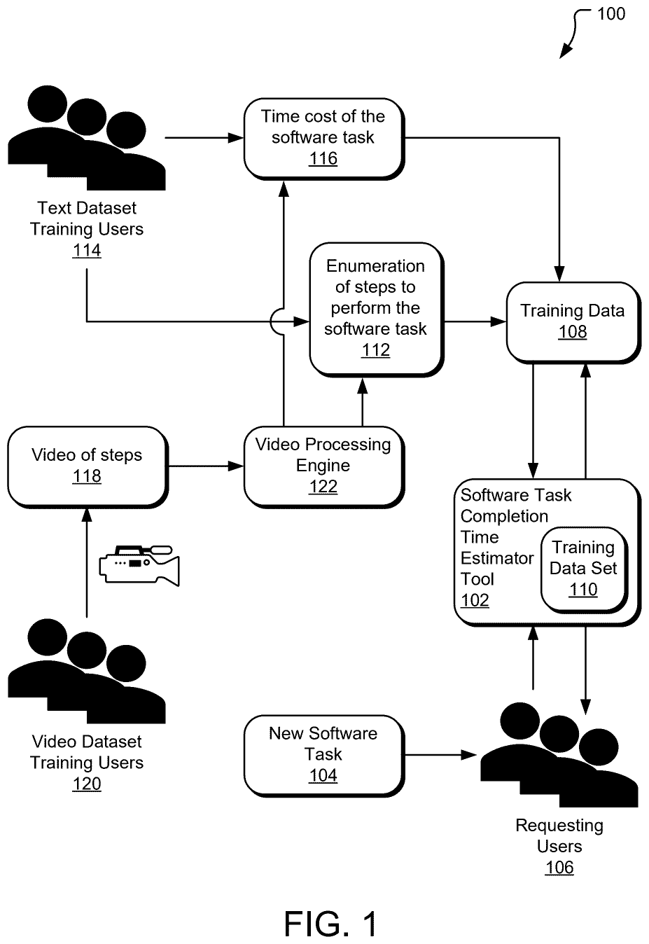

FIG. 1 illustrates an example system 100 for estimating software task completion time. The system 100 includes a software task completion time estimator tool 102 that receives as input training data 108 to create a training data set 110. The estimator tool 102 utilizes the training data set 110 to estimate completion time for future software tasks, such as a new software task 104, as requested by requesting users 106. In various implementations, the new software task 104 may be a singular discrete task or a suite of software tasks within a larger software project.

For various entities (e.g., large software companies), security or compliance mandated tasks (e.g., debugging, security patching, and upgrading tasks) can affect a large number of software services, components, or artifacts and responsible teams. A security or compliance team can be responsible for completing these tasks on behalf of other teams, or the security or compliance team can oversee completion of these tasks by the other teams. Regardless, the security or compliance team defines a listing of steps required to perform a software task to move the responsible teams from non-compliant to compliant.

In some implementations, this definition is provided directly by the security or compliance team in a simple or structured text format describing the task to be completed step-by-step. Here, this is illustrated as enumeration of steps 112 to perform the software task that is entered by text dataset training users 114, such as the security or compliance team. Specifically, the enumeration of steps 112 is created directly by the text dataset training users 114 to be entered as part of the training data 108. Further, the text dataset training users 114 enter a time cost 116 of the software task to assign a time cost to the software task overall (e.g., 1-hour to perform the entire software task) and/or the individual steps performed to complete the software task (e.g., 5-minutes to update a hardware driver, 5-minutes to restart an associated computer, and 5-minutes to verify correct functioning of the new hardware driver on the associated computer). The time cost 116 of the software task data also becomes part of the training data 108.

In other implementations, the security or compliance team creates a video clip that walks through the steps to perform the software task. Here, this is illustrated as video of steps 118 being performed by the security or compliance team that functions as video dataset training users 120. The video of steps 118 can then be provided as input to a large-language model (LLM) or a video/image processing artificial-intelligence (AI) engine 122, such as an image-to-text machine learning (ML) model. The video processing engine 122 can then analyze the video of steps 118 and identify and break it up distinct steps that are then converted into a text enumeration of steps 112 to perform the software task that describe the actions depicted in the video of steps 118. The video processing engine 122 can further measure the time required to perform each step and convert that into the time cost 116 for the software task overall and/or the individual steps performed to complete the software task.

The video processing engine 122 is illustrated in FIG. 1 as specific to the system 100 and described above in only the context of the system 100. In other implementations, the video processing engine 122 is a part of a separate system that is capable of parsing video to identify specific steps and duration of the identified steps or time between the identified steps. The system 100 may leverage this information as metadata tagged to the video of steps 118. In some implementations, the tool 102 is used to infer this information from the video of steps 118. In some implementations, the video processing engine 122 is supplied with screen captures from security or compliance teams' previous task performances at the start and at the completion of task performance to serve as the video of steps 118, where the screen captures have metadata in the form of time-stamped information for changes made. In these implementations, the tool 102 is also able to infer information from the video of steps 118.

Pairings of text enumeration of steps 112 and the associated time cost 116 to execute a software task received either directly from the text dataset training users 114 or indirectly from the video dataset training users 120 via the video processing engine 122 become part of the training data 108. Given the cost estimates for past software tasks that are the same or similar to a new software task 104, the estimator tool 102 creates the training data set 110 and uses the training data set 110 to estimate completion time for future software tasks, such as the new software task 104, as requested by the requesting users 106.

In some example implementations, it may be technically advantageous to adopt the presently disclosed technology to streamline a software development cycle. When developing new software, a substantial amount of effort (e.g., 20%) is focused on resolving potential security threats and satisfying compliance issues. This interrupts the regularly software development workflow. Compounding the issue is that an interrupted user has no sense at the onset of the scope of the delay that will occur to execute a security/compliance software task. The presently disclosed technology supplies an estimated completion time along with the software task to be completed to better inform the interrupted user. This allows the interrupted user to better plan for completing the software task (e.g., by making sure sufficient time is reserved for its completion before initiating the software task or securing additional resources (e.g., outside vendors) to execute the software task if the interrupted user is unable or unwilling to execute it timely). This yields technical benefits in increased overall productivity, efficiency, and time-management for the interrupted user and all users across the organization or software development team that the software task is applicable to. This may also benefit a technical team tasked with scheduling time with company employees to perform routine software upgrades and other software maintenance operations across an organization. Further, at a higher level, this allows the organization to more efficiently manage human resources by allowing more accurate estimates of man-hours needed to complete routine company-wide software maintenance tasks.

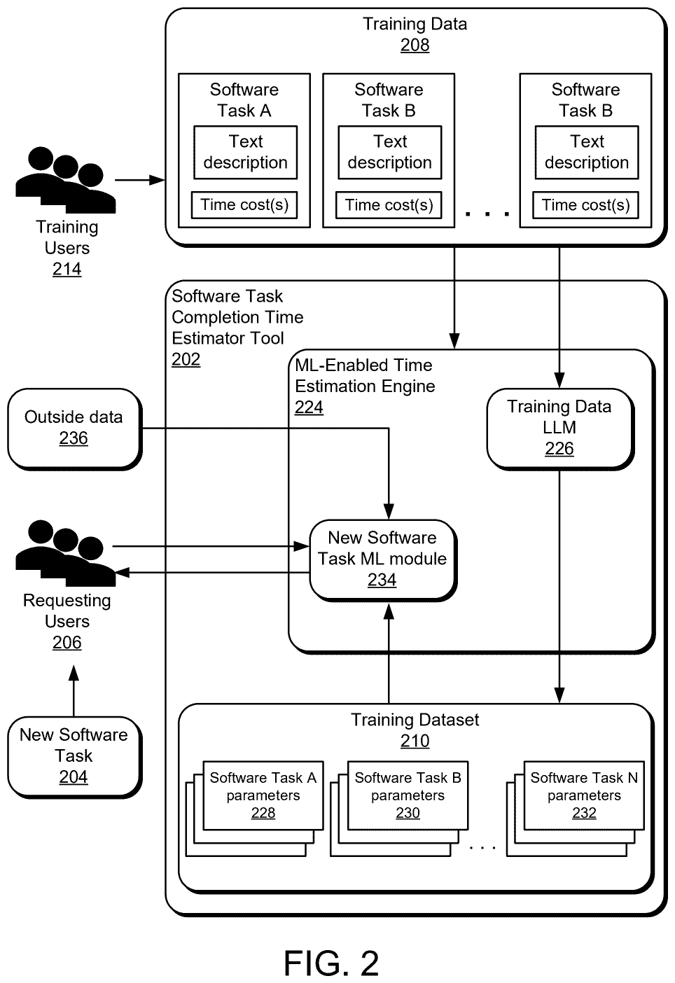

FIG. 2 illustrates an example software task completion time estimator tool 202 configured to estimate completion time for a variety of incoming new software tasks, such as a new software task 204, based on training data 208 from previously completed software tasks. The tool 202 is a software tool usable by requesting users 206, who may be computing system or network administrators. The requesting users 206 use the tool 202 to generate an estimated completion time for executing the new software task 204 based on a prior experiences with prior software tasks (e.g., Software Task A, Software Task B . . . , Software Task N) illustrated as the training data 208.

The training data 208 is organized as a series of data inputs received from training users 214, each input corresponding to a software task instance (e.g., Software Task A, Software Task B . . . , Software Task N). Example data inputs include: user text enumeration of steps to complete the task (illustrated as “Text Description”), estimated completion time for the software task and/or individual steps therein (illustrated as “Time Cost(s)”), a training user skill modifier, and so on. Examples of the text description include: faulty packet version identification, location of a faulty packet, instructions to run an update script. If the requesting users 206 are expected to be end-users, the text description may be more granular, e.g., navigate through menus, click buttons, etc. If the requesting users 206 are expected to be IT professionals, the description may be more general.

In various implementations, the training data 208 and underlying steps are assigned time costs. This may be an overall time cost to execute the software task, that is then parsed by the training data LLM 226 (discussed below) to assign individual time costs to each underlying step within the software task. In other implementations, the training users 214 may input the underlying time costs to each underlying step within the software task. While the training users 214 and the requesting users 206 are illustrated as distinct parties, the computing system or network administrators making up the training users 214 and the requesting users 206 may comprise one or both categories based on whether they are currently functioning to provide training data or to request completion time for the new software task 204.

The training data 208 is input into the tool 202 that includes an artificial intelligence enabled time estimation engine 224. The time estimation engine 224 incorporates a training data large-language model (LLM) 226 and a new software task machine-learning (ML) module 234 that are used in conjunction to process and parameterize previously-implemented software tasks (e.g., training data 208), compare the previously-implemented software tasks to the new software task 204, and identify commonalities therebetween to predict the estimated time required to implement the new sequence of operations to complete the new software task 204.

The training data large-language model (LLM) 226 parses and parameterizes the incoming training data 208 into a set of predefined parameter fields for each of the software tasks. For example, the training data LLM 226 may identify keywords or key-phrases within the user text enumeration of steps to create a series of training vectors, each with parameters derived from the training data 208.

The training data LLM 226 converts the training data 208 into a training dataset 210 that includes parameterized data, organized by software task instance (e.g., Software Task A parameters 228, Software Task B parameters 230 . . . , Software Task N parameters 232). Example parameters that may be derived from the training data 208 include: lines of code needed to execute the software task, a number of components that require updating in the software task, a number of manual steps to perform the software task (e.g., a number of mouse clicks or keystrokes, potentially including wait time therebetween to wait for a process to happen, such as build to complete or to get permissions), a training user skill modifier (in some implementations, a numerical rating that passes through from the training data 208), software task type, approvals required to run the software task, etc. Some or all of the derived parameters may further have time costs associated therewith.

An initial training dataset 210 may be created by analyzing the time cost data within the training data 208 corresponding to successfully completed software tasks and analyzing the work involved to complete these tasks. The training data LLM 226 interprets the steps involved to complete the software task either in text format or analyzes a video of an individual performing the software task. The training data LLM 226 further processes the steps to break them down into parameters, as discussed above.

In some implementations, the training data LLM 226 includes a trained semantic similarity model that vectorizes the provided text description and time cost. This vectorization operation translates the text descriptions into a vectors defined within a common vector space in which each vector-to-vector separation correlates with a learned degree of semantic similarity of the vectors. The trained semantic similarity model is, for example, a transformer-based natural language model that learns context and thus meaning by tracking relationships in sequential data. Examples of transformer-based natural language models include sequence-to-sequence models, generative pre-trained transformer (GPT) models, and bidirectional encoder representations from transformers (BERT) models. Once re-defined within the above-described common vector space, a suitable comparative metric (e.g., dot product or cosine similarity) is employed to compute the semantic similarity metric between a text description of the new software task 204 and the training dataset 210 vectors.

For example, the training data 208 may be provided to the training data LLM 226 in the form of a text description and total time to execute (e.g., [‘description’, execute_time]). The training data LLM 226 processes and vectorizes this information. For example, if the training data LLM 226 determines from the text description that the 5 lines of code will need to be updated, across four steps that will take 10 minutes, the training vector may be written as: [lines_of_code=5, update_count=1, step_count=4, fix_time=10 min]]. A text description of the new software task 204 is also provided (but absent a time cost) and similarly vectorized. The ML model 234 may then compute the semantic similarity metric between the vectorized new software task 204 and the training dataset 210 vectors.

Another example LLM instance used to break down an example software task into an example parameter set using an off-the shelf large language model (LLM), such as GPT-3 or GPT-4, BERT, or sequence-to-sequence model follows. The training data 208 includes a structured description of the software task (or video that is parse-able into a structured description) and a prompt for the AI to interpret the training data 208. An example prompt is: “How many mouse clicks and lines of code will I need to upgrade a NuGet package version in Visual Studio”? The prompts may be preset and preloaded into the training data LLM 226 or manually provided to the training data LLM 226. The output from the training data LLM 226 may include something like the following.

The number of mouse clicks and lines of code required to upgrade a NuGet package version in Visual Studio can vary depending on your specific project structure, Visual Studio version, and the changes introduced in the updated package. Here's a general overview of the process:

Steps to Upgrade a NuGet Package in Visual Studio:

Option No. 1—Using Visual Studio UI:
1. **Open Solution:**
   Mouse Clicks: Open Visual Studio and load your solution.
   Lines of Code: None.
2. **Open NuGet Package Manager:**
   Mouse Clicks: Right-click on the project in Solution Explorer>Manage NuGet Packages.
   Lines of Code: None.
3. **Select Package to Upgrade:**
   Mouse Clicks: Go to the “Installed” tab, find the package to upgrade.
   Lines of Code: None.
4. **Select Version to Upgrade:**
   Mouse Clicks: Click on the version dropdown and select the desired version.
   Lines of Code: None.
5. **Click “Update” Button:**
   Mouse Clicks: Click the “Update” button.
   Lines of Code: None.
6. **Review Changes:**
   Mouse Clicks: Review any changes or prompts.
   Lines of Code: None.
7. **Build Solution:**
   Mouse Clicks: Click “Build”>“Build Solution.”
   Lines of Code: None.

Option No. 2—Using Package Manager Console:
1. **Open Package Manager Console:**
   Mouse Clicks: View>Other Windows>Package Manager Console.
   Lines of Code: None.
2. **Run Update Command:**
   Mouse Clicks: None.
   Lines of Code: Type ‘Update-Package PackageName’ and press Enter.
3. **Review Changes:**
   Mouse Clicks: Review any changes or prompts.
   Lines of Code: None.
4. **Build Solution:**
   Mouse Clicks: Click “Build”>“Build Solution.”
   Lines of Code: None.
###Total:
   **Mouse Clicks:** Approximately 4-6 clicks.
   **Lines of Code:** None to a few lines if you're scripting the update using Package Manager Console.

Keep in mind that these numbers are estimates and can vary based on your specific project setup and the updates introduced in the new NuGet package version. Always review release notes and documentation for any breaking changes or additional steps required for the upgrade.

In this manner, the training data LLM 226 was able to parameterize the training data 208 into “mouse clicks” and “lines of code” parameters, which will in turn be used to create the training dataset 210. In further implementations, more complex tasks may be broken down by the training data LLM 226 with steps and sub-steps as long as the description of the steps in the training data 208 is provided in a consistent format that can be interpreted by the training data LLM 226. As noted above, the parameters may also be derived by the training data LLM 226 using a video or screen recording of a user performing software task. This video could be pre-processed by a video processing system to derive a text description that may be used by the training data LLM 226 to derive parameters. To obtain the initial cost training data, the training users 214 may directly provide time(s) to perform the software task. The initial cost training data may also be derived from the video or screen recording of a user performing software task.

The tool 202 further utilizes the time estimation engine 224 to perform customized estimates of completion time for new software tasks (e.g., new software task 204) using the training dataset 210, which may be a fixed dataset or a dynamic dataset that is continually updated with additional training data 208 as requesting users 206 execute the software tasks. Specifically, requesting users 206 use the tool 202 to estimate the completion time for the new software task 204. Upon request by the requesting users 206, the tool 202 uses the new software task ML module 234, which uses a predictive algorithm such as XGBoost or other predictive AI models that are trained on the training dataset 210. The ML module 234 identifies similarities between the new software task 204 and the software tasks and associated parameters with the training dataset 210. The ML module 234 assigns related parameters to the new software task 204 and uses time costs stored in the training dataset 210 that are associated with the assigns related parameters to estimate a completion time for the new software task 204. In some cases, the ML module 234 will infer time costs for basic steps, such as a login to Azure is expected to take 2 minutes and a restart of a user device is expected to take 5 minutes. These inferences may be made based on the training dataset 210, outside data 236 (e.g., data available to the ML module 234 over the Internet), or a combination thereof. The ML module 234 may also infer completion time for sub-combinations of steps that are commonly found together with the training dataset 210, such as a restart of a user device and a re-login to the user device.

The estimated completion time for the new software task 204 as calculated by the engine 224 is communicated back to the requesting users 206. In the case of the dynamic dataset, successful executions of the new software task 204 and associated time costs are loaded back into the tool 202 as additional training data 208, which may be weighted favorably over previous training data 208. A variety of other dynamic updates to the training dataset 210 may be executed based on recency or observed accuracy for future software tasks (e.g., by using updated parameter weights).

In various implementations, the ML module 234 is, for example, a transformer-based model such as a generative pre-trained transformer (GPT) model, a sequential model, or a recurrent neural network (RNN). In one implementation, the ML module 234 is a model specifically trained (or refined) based on the training dataset 210 and the outside data 236 including examples of inputs (e.g., user-provided natural language feedback) and outputs (e.g., alert rules generated based on the user feedback or function calls to enforce the alert rules).

In an example implementation, a security team (training users 214) identifies and resolves software security threats and creates tickets with text descriptions on how the security threats (training data 208) were resolved and how long each resolution took. This training data 208 is used to populate the training dataset 210. When a new security threat (new software task 204) is identified and is to be executed by requesting users 206 throughout an organization, such as how to update a packet solution, re-build, update policies, etc., the tool 202 can be used to estimate the time cost of executing the new software task 204 to improve the productivity of the requesting users 206. Generating the associated training data 208 is a 1-time cost to the organization, but implementing new solutions has a repeatable (and predictable) time cost that occurs throughout the organization. Thus, the requesting users 206 are supplied with a technical benefit in being supplied a predicted time to execute the new software task 204 prior to beginning the new software task 204 based on prior similar software tasks that populated the training dataset 210.

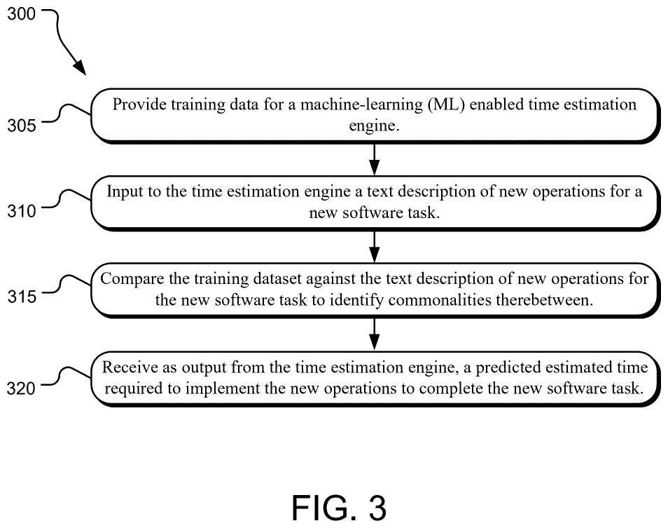

FIG. 3 illustrates example operations 300 for estimating software task completion time for predictable and repeatable software tasks (e.g., software compliance, security patching, and upgrading tasks). A first providing operation 305 provides training data for a machine-learning (ML) enabled time estimation engine. The training data includes, for each of multiple previously-implemented software tasks, a text description of operations performed to implement the software task and a total time required to implement the software task. The text descriptions of operations may include sequences of operations. The training data may further include time required to complete one or more of the operations performed to implement the software task.

In some implementations, the training data is supplied to the time estimation engine as user generated data describing a previously-implemented software task. In other implementations, a video processing engine applies an image-to-text ML model to a video or screen capture of a previously-implemented software task to generate the text description of operations of the previously-implemented software task. The image-to-text ML model may further generate the total time required to implement the previously-implemented software task using the video or screen capture of the previously-implemented software task.

The time estimation engine incorporates a large-language model (LLM) to parameterize the training data into a training dataset. In various implementations, the parameters for the training dataset include one or more of: lines of code required to execute the software task, a number of components that require updating in the software task, or a number of manual steps to perform the software task, for example.

An inputting operation 310 inputs to the time estimation engine a text description of new operations for a new software task. The text description of new operations may be similarly formatted and contain similar content to the text description of operations for the training data.

A comparing operation 315 compares the training dataset against the text description of new operations for the new software task to identify commonalities therebetween. This allows the time estimation engine to predict the estimated time required to implement the new sequence of operations to complete the new software task. A receiving operation 320 receives as output from the time estimation engine, a predicted estimated time required to implement the new operations to complete the new software task.

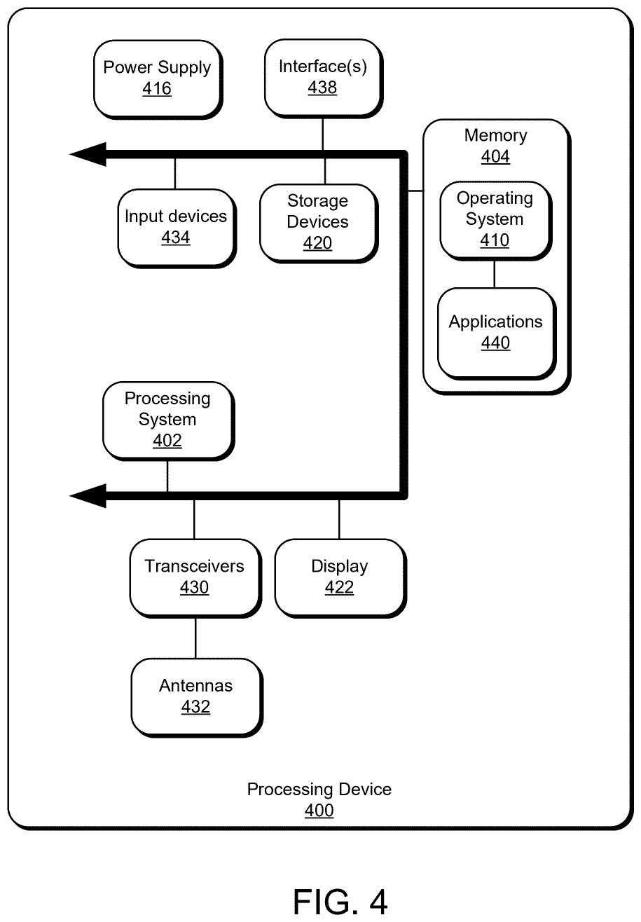

FIG. 4 illustrates an example schematic of a processing device 400 suitable for implementing aspects of the disclosed technology. The processing device 400 includes a processing system 402, memory 404, a display 422, and other interfaces 438 (e.g., buttons). The processing system 402 may include one or more computer processing units (CPUs), graphics processing units (GPUs), etc.

The memory 404 generally includes both volatile memory (e.g., random access memory (RAM)) and non-volatile memory (e.g., flash memory). An operating system 410 resides in the memory 404 and is executed by the processing system 402. One or more applications 440 (e.g., the time estimation engine 224 of FIG. 2) are loaded in the memory 404 and executed on the operating system 410 by the processing system 402. In some implementations, aspects of the software task completion time estimator tool 102 of FIG. 1 are loaded into memory of different processing devices connected across a network. The applications 440 may receive inputs from one another as well as from various input local devices 434 such as a microphone, input accessory (e.g., keypad, mouse, stylus, touchpad, gamepad, racing wheel, joystick), or a camera.

Additionally, the applications 440 may receive input from one or more remote devices, such as remotely-located servers or smart devices, by communicating with such devices over a wired or wireless network using more communication transceivers 430 and an antenna 432 to provide network connectivity (e.g., a mobile phone network, Wi-Fi®, Bluetooth®). The processing device 400 may also include one or more storage devices 420 (e.g., non-volatile storage). Other configurations may also be employed. In one implementation, the significant software task completion time estimator tool 202 of FIG. 2 is an application executing on the processing device 400 or as a distributed application with different components executing on many different devices. The significant cohort identifier connects to a centralized telemetry storage repository over a network that stores telemetry data from many different devices.

The processing device 400 further includes a power supply 416, which is powered by one or more batteries or other power sources, and which provides power to other components of the processing device 400. The power supply 416 may also be connected to an external power source (not shown) that overrides or recharges the built-in batteries or other power sources.

The processing device 400 may include a variety of tangible computer-readable storage media and intangible computer-readable communication signals. Tangible computer-readable storage can be embodied by any available media that can be accessed by the processing device 400 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data.

Tangible computer-readable storage media includes RAM, read-only memory (ROM), electrically erasable programmable read-only memory (EEPROM), flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 400. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, adding or omitting operations, unless explicitly claimed otherwise or a specific order is inherently necessitated by the claim language.

Implementations disclosed and claimed herein include a method for estimating time to implement software tasks comprising providing training data for a machine-learning (ML) enabled time estimation engine that includes, for each of multiple implemented software tasks, a text description of operations performed to implement the software task and a total time required to implement the software task; inputting to the time estimation engine a text description of new operations for a new software task; and receiving as output from the time estimation engine, an estimated time required to implement the new operations to complete the new software task.

The time estimation engine may incorporate a large-language model (LLM) to parameterize the training data into a training dataset.

The method may further comprise comparing the training dataset against the text description of new operations for the new software task to identify commonalities and predict the estimated time required to implement the new operations to complete the new software task.

The parameters for the training dataset may include one or more of: lines of code required to execute the software task, a number of components that require updating in the software task, or a number of manual steps to perform the software task.

The training data may further include time required to complete one or more of the operations performed to implement the software task.

The training data may be supplied to the time estimation engine as user generated data describing an implemented software task.

The method may further comprise applying an image-to-text ML model to a video or screen capture of an implemented software task to generate the text description of operations of the implemented software task.

The image-to-text ML model may further generate the total time required to implement the implemented software task using the video or screen capture of the implemented software task.

The software tasks may be one or more of compliance tasks, security patching tasks, or upgrading tasks.

The text descriptions of operations may include sequences of operations.

Implementations disclosed and claimed herein also include a machine-learning (ML) enabled software task completion time estimator comprising a large-language model (LLM) configured to receive training data, for a set of multiple implemented software tasks, a text description of operations performed to implement each software task and a total time required to implement each software task; and a time estimation engine to receive a text description of new operations for a new software task and output an estimated time required to implement the new operations to complete the new software task.

The LLM may parameterize the training data into a training dataset.

The time estimation engine may compare the training dataset against the text description of new operations for the new software task to identify commonalities and predict the estimated time required to implement the new operations to complete the new software task.

The training data may further include time required to complete one or more of the operations performed to implement each software task.

The training data may be supplied to the time estimation engine as user generated data describing an implemented software task.

The ML enabled software task completion time estimator may further comprise a video processing engine to apply an image-to-text ML model to a video or screen capture of an implemented software task to generate the text description of operations of the implemented software task.

The video processing engine may further generate the total time required to implement the implemented software task using the video or screen capture of the implemented software task.

Implementations disclosed and claimed herein also include a machine-learning (ML) enabled software task completion time estimator comprising and a large-language model (LLM) and a a time estimation engine. The LLM is to receive training data, for a set of multiple implemented software tasks, a text description of operations performed to implement each software task and a total time required to implement each software task; and parameterize the training data into a training dataset. The time estimation engine is to receive a text description of new operations for a new software task, compare the training dataset against the text description of new operations for the new software task to identify commonalities, and predict an estimated time required to implement the new operations to complete the new software task.

The ML enabled software task completion time estimator may further comprise a video processing engine to apply an image-to-text ML model to a video or screen capture of an implemented software task to generate the text description of operations of the implemented software task.

The video processing engine may be configured to generate the total time required to implement the implemented software task using the video or screen capture of the implemented software task.

The above specification, examples, and data provide a complete description of the structure and use of example implementations.

What is claimed is:

1. A method for estimating time to implement software tasks comprising:
providing training data for a machine-learning (ML) enabled time estimation engine that includes, for each of multiple implemented software tasks, a text description of operations performed to implement the software task and a total time required to implement the software task;
inputting to the time estimation engine a text description of new operations for a new software task; and
receiving as output from the time estimation engine, an estimated time required to implement the new operations to complete the new software task.

2. The method of claim 1, wherein the time estimation engine incorporates a large-language model (LLM) to parameterize the training data into a training dataset.

3. The method of claim 2, further comprising:
comparing the training dataset against the text description of new operations for the new software task to identify commonalities and predict the estimated time required to implement the new operations to complete the new software task.

4. The method of claim 2, wherein parameters for the training dataset include one or more of: lines of code required to execute the software task, a number of components that require updating in the software task, or a number of manual steps to perform the software task.

5. The method of claim 2, wherein the training data further includes time required to complete one or more of the operations performed to implement the software task.

6. The method of claim 1, wherein the training data is supplied to the time estimation engine as user generated data describing an implemented software task.

7. The method of claim 1, further comprising:
applying an image-to-text ML model to a video or screen capture of an implemented software task to generate the text description of operations of the implemented software task.

8. The method of claim 7, wherein the image-to-text ML model further generates the total time required to implement the implemented software task using the video or screen capture of the implemented software task.

9. The method of claim 1, wherein the software tasks are one or more of compliance tasks, security patching tasks, or upgrading tasks.

10. The method of claim 1, wherein the text descriptions of operations include sequences of operations.

11. A machine-learning (ML) enabled software task completion time estimator comprising:
a large-language model (LLM) configured to receive training data, for a set of multiple implemented software tasks, a text description of operations performed to implement each software task and a total time required to implement each software task; and
a time estimation engine to receive a text description of new operations for a new software task and output an estimated time required to implement the new operations to complete the new software task.

12. The ML enabled software task completion time estimator of claim 11, wherein the LLM is to parameterize the training data into a training dataset.

13. The ML enabled software task completion time estimator of claim 12, wherein the time estimation engine compares the training dataset against the text description of new operations for the new software task to identify commonalities and predict the estimated time required to implement the new operations to complete the new software task.

14. The ML enabled software task completion time estimator of claim 12, wherein the training data further includes time required to complete one or more of the operations performed to implement each software task.

15. The ML enabled software task completion time estimator of claim 11, wherein the training data is supplied to the time estimation engine as user generated data describing an implemented software task.

16. The ML enabled software task completion time estimator of claim 11, further comprising:
a video processing engine to apply an image-to-text ML model to a video or screen capture of an implemented software task to generate the text description of operations of the implemented software task.

17. The ML enabled software task completion time estimator of claim 16, wherein the video processing engine is further to generate the total time required to implement the implemented software task using the video or screen capture of the implemented software task.

18. A machine-learning (ML) enabled software task completion time estimator comprising:
a large-language model (LLM) to:
receive training data, for a set of multiple implemented software tasks, a text description of operations performed to implement each software task and a total time required to implement each software task; and
parameterize the training data into a training dataset; and
a time estimation engine to:
receive a text description of new operations for a new software task;
compare the training dataset against the text description of new operations for the new software task to identify commonalities; and
predict an estimated time required to implement the new operations to complete the new software task.

19. The ML enabled software task completion time estimator of claim 18, further comprising:
a video processing engine to apply an image-to-text ML model to a video or screen capture of an implemented software task to generate the text description of operations of the implemented software task.

20. The ML enabled software task completion time estimator of claim 19, wherein the video processing engine is configured to generate the total time required to implement the implemented software task using the video or screen capture of the implemented software task.
